(19) United States
(12) Patent Application Publication
(10) Pub. No.: US 2026/0319562 A1
(43) Pub. Date: Oct. 15, 2026

(54) METHOD AND APPARATUS FOR MANAGING POWER STATE OF STORAGE DEVICES

(71) Applicant: Samsung Electronics Co., Ltd., Suwon-si (KR)

(72) Inventors: Amit DEVGAN, Bengaluru (IN); Byju RAVINDRAN, Bengaluru (IN); Raj Kumar DANI, Bengaluru (IN); Sathish Kumar MAHADMA GANDHI, Bengaluru (IN)

(73) Assignee: Samsung Electronics Co., Ltd., Suwon-si (KR)

(21) Appl. No.: 19/235,171

(22) Filed: Jun. 11, 2025

(30) Foreign Application Priority Data
Apr. 10, 2025 (IN) 202541035114

(51) Int. Cl. G06F 1/3209; H02J 3/00

(52) U.S. Cl. CPC G06F 1/3209; H02J 3/003

(57) ABSTRACT

A method for managing power state of one or more storage devices associated with a storage server includes receiving a power token generated for each of one or more host applications from service entity associated with storage server. The power token indicates power expectation corresponding to each host application. The storage server dynamically configures one or more power tiers based on the power expectation indicated in power token for each host application. Each power tier comprises group of storage devices configured to operate at a power state corresponding to the power tier. The storage server allocates each host application to a one power tier among configured power tiers for execution at the desired power state, based on the received power token. Some example embodiments provide a dynamic power management strategy to reduce power consumption by storage devices.

### CROSS-REFERENCE TO RELATED APPLICATIONS

This application is based on and claims priority under 35 U.S.C. § 119 to Indian Patent Application No. 202541035114, filed on Apr. 10, 2025, in the Office of the Controller General of Patents, Designs and Trade Marks (CGPDTM) in India, the disclosure of which is incorporated by reference herein in its entirety.

### BACKGROUND

Some example embodiments relate to storage devices. Particularly, some example embodiments relate to a method and/or an apparatus for managing power state of one or more storage devices associated with a storage server.

The storage industry, particularly data centers, may be facing a critical challenge in the form of high power consumption and an associated environmental impact, which may be largely driven by the energy demands of storage devices, such as Solid State Devices (SSDs) within the storage devices. The storage devices may consume substantial power, both during active operations and also when idle. Frequent transitions of the storage devices between power states, inefficient power management techniques, and/or increasing power requirements or expectations of higher-capacity and/or higher-performance storage devices further exacerbate the energy demands of storage devices.

The advent of Artificial Intelligence (AI) and/or other demanding workloads may further necessitate higher performance of storage devices during peak hours. As data centers continue to scale and demand for storage capacity grows, the energy consumption of SSDs becomes a major factor in overall data center power usage.

Additionally or alternatively, there is no effective mechanism currently to manage the power consumption of storage devices based on their actual workload. For example, storage devices may consume significant power even when they are not actively serving I/O requests, leading to unnecessary energy waste.

The information disclosed is only for enhancement of understanding of the general background of the invention and should not be taken as an acknowledgement or any form of suggestion that this information forms the prior art already known to a person of ordinary skill in the art.

### SUMMARY

It may be advantageous or desirable to provide a mechanism that addresses the above challenges and/or implement dynamic power management strategies.

According to some example embodiments, a method of managing power state of one or more storage devices associated with a storage server includes receiving a power token generated for each of one or more host applications from a service entity associated with the storage server. The power token indicates power expectation corresponding to each of the one or more host applications. The method further includes configuring dynamically one or more power tiers based on the power expectation indicated by the power token received for each of the one or more host applications. Each of the one or more power tiers comprises a group of storage devices configured to operate at a desired power state. The method includes allocating each of the one or more host applications to a suitable power tier among the one or more power tiers for execution at the desired power state, based on the power token received for each of the one or more host applications.

Alternatively or additionally according to some example embodiments, a storage server for managing power state of one or more storage devices associated with the storage server includes a processor and a memory communicatively coupled to the processor. The memory is configured to store processor-executable instructions, which, on execution by the processor, causes the storage server to receive a power token generated for each of one or more host applications from a service entity associated with the storage server. The power token indicates power expectation corresponding to each of the one or more host applications. The storage server further configures dynamically one or more power tiers based on the power expectation indicated by the power token received for each of the one or more host applications. Each of the one or more power tiers comprises a group of storage devices configured to operate at a desired power state. The storage server allocates each of the one or more host applications to a suitable power tier among the one or more power tiers for execution at the desired power state, based on the power token received for each of the one or more host applications.

Alternatively or additionally according to some example embodiments, a system includes one or more storage devices, and a storage server configured to manage a power state of the one or more storage devices associated with the storage server. The storage server comprises a processor, and a memory communicatively coupled to the processor. The memory is configured to store processor-executable instructions, which, on execution, causes the system to receive a power token generated for each of one or more host applications from a service entity associated with the storage server, wherein the power token indicates power expectation corresponding to each of the one or more host applications, configure dynamically one or more power tiers based on the power expectation indicated by the power token received for each of the one or more host applications, wherein each of the one or more power tiers comprises a group of storage devices associated with the storage server that are configured to operate at a desired power state, and allocate each of the one or more host applications to a suitable power tier among the one or more power tiers for execution at the desired power state, based on the power token received for each of the one or more host applications. Each of the one or more storage devices are configured to execute the respective host applications allocated to the respective one or more storage devices based on the power tiers.

According to some example embodiments, the power tiers include a highest power tier, a high power tier, a medium power tier, and a low power tier.

According to some example embodiments, the processor is configured to assign an artificial intelligence/machine learning (AI/ML) applications to the highest power tier among the power tiers.

According to some example embodiments, the processor is configured to assign a transactional application to the high power tier among the power tiers.

According to some example embodiments, the processor is configured to assign a web application to the medium power tier among the power tiers.

According to some example embodiments, the processor is configured to assign an archival application to the low power tier among the power tiers.

The foregoing summary is illustrative only and is not intended to be in any way limiting. In addition to the illustrative aspects, embodiments, and/or features described above, further aspects, embodiments, and features will become apparent by reference to the drawings and the following detailed description of some example embodiments.

### BRIEF DESCRIPTION OF DRAWINGS

The accompanying drawings, which are incorporated in and constitute a part of this disclosure, illustrate exemplary embodiments and, together with the description, explain the disclosed principles. In the figures, the left-most digit(s) of a reference number identifies the figure in which the reference number first appears. The same numbers are used throughout the figures to reference like features and components. Some example embodiments of system and/or methods in accordance with embodiments of the present subject matter are now described, by way of example only, and regarding the accompanying figures, in which:

FIG. 1 shows an exemplary architecture for managing power state of one or more storage devices associated with a storage server, in accordance with some embodiments of the present disclosure;

FIG. 2A shows a detailed block diagram of a storage server for managing power state of one or more storage devices associated with the storage server, in accordance with some embodiments of the present disclosure;

FIG. 2B shows an exemplary block diagram of one or more power tiers configured based on the power requirement indicated by the power token received for each of the one or more host applications, in accordance with some embodiments of the present disclosure;

FIG. 3 shows an exemplary flowchart illustrating a method of managing power state of one or more storage devices associated with a storage server, in accordance with some embodiments of the present disclosure; and

FIG. 4 illustrates a general computer system architecture, in accordance with some embodiments of the present disclosure.

It should be appreciated by those of ordinary skill in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

In the present document, the word “exemplary” is used herein to mean “serving as an example, instance, or illustration.” Any embodiment and/or implementation of the present subject matter described herein as “exemplary” is not necessarily to be construed as preferred and/or advantageous over other embodiments.

While some example embodiments may be susceptible to various modifications and alternative forms, specific example embodiment thereof has been shown by way of example in the drawings and will be described in detail below. It should be understood, however, that it is not intended to limit the disclosure to the specific forms disclosed, but on the contrary, the disclosure is to cover all modifications, equivalents, and alternative falling within the scope of the disclosure.

The terms “comprises”, “comprising”, “includes”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

As referred to herein, the term “service entity” is or includes a computing environment associated with the storage server. In some example embodiments, users may access one or more host applications from the application server, as services, remotely through their connected devices (also referred to as one or more client devices), through the service entity. As used herein, the term “user” may refer to an operator and/or to an artificial intelligence (A.I.) agent, such as but not limited to an agent operating as a Large Language Model (LLM). Example embodiments are not limited thereto.

There is a desire to provide a mechanism for managing power states of one or more storage devices associated with a storage server. The one or more storage devices consume significant power even when they are not actively serving I/O requests; therefore it is desirable to manage the power consumption of storage devices based on their actual workload. The present disclosure provides a method and/or an apparatus, e.g., a storage server for managing power states of one or more storage devices associated with the storage server. In the present disclosure, one or more power tiers are configured dynamically based on the power requirement or power expectation indicated by a power token received for each of the one or more host applications. This is distinguished over a traditional way of configuring storage tiers for high-performance applications, which may primarily be based on a capacity. Each of the one or more power tiers comprises a group of storage devices configured to operate at a desired power state, managing the power consumption of the storage devices based on their actual workload. Each of the one or more host applications are allocated to a suitable power tier among the one or more power tiers for execution at the desired power state, which in turn may advantageously reduce idle power, and/or may advantageously minimize or reduce power state transitions. By implementing dynamic power management strategies the storage industry may significantly reduce the power consumption and/or the carbon emissions of data centers, leading to lower operational costs and/or a more sustainable future, while maintaining cost-efficiency during off-peak periods.

In the following detailed description of some example embodiments, reference is made to the accompanying drawings that form a part hereof, and in which are shown by way of illustration specific example embodiments may be practiced. These example embodiments are described in sufficient detail to enable those of ordinary skill in the art to practice example embodiments, and it is to be understood that other embodiments may be utilized and that changes may be made without departing from the scope of inventive concepts. The following description is, therefore, not to be taken in a limiting sense.

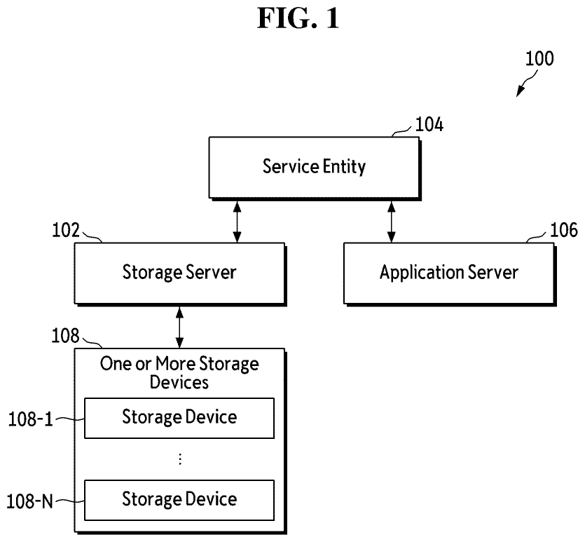

FIG. 1 shows an exemplary architecture for managing power state of one or more storage devices associated with a storage server.

Exemplary architecture 100 comprises a storage server 102, a service entity 104, an application server 106, and a storage device 108₁ to a storage device 108_{N} (collectively referred to as one or more storage devices 108) associated with the storage server 102. In some example embodiments, the storage server 102 may be a specialized computer and/or a device designed to store and manage data. In some example embodiments, the storage server 102 may be configured to function as a central repository for one or more of files, documents, databases, and other digital assets, making them accessible to users and/or to one or more host applications within a network. In some example embodiments, storage server 102 may be configured as part of a cloud-based infrastructure, offering scalability and flexibility.

In some example embodiments, the storage server 102 may be communicatively connected to the service entity 104 associated with the storage server 102 through a communication network. The communication network may be at least one of a wired communication network and wireless communication network. In some example embodiments, the service entity 104 may be or may include, or be included in, a computing model associated with the storage server 102. Alternatively or additionally in some example embodiments, the service entity 104 may be configured within the storage server 102.

In some example embodiments, the storage server 102 may be communicatively connected to the one or more storage devices 108. The one or more storage devices 108 may include, but are not limited to, storage devices such as one or more of Hard Disk Drives (HDDs), Solid-State Drives (SSDs), and tape drives. In some example embodiments, the one or more storage devices 108 associated with the storage server 102 may be one or more non-volatile solid state memory units. In some example embodiments, the one or more storage devices 108 may also include, without limiting to, one or more of at least one NVMe (Non-Volatile Memory express) SSDs, at least one logically-addressable Solid State Disks (laSSDs), with an laSSD including a storage device controller, such as an SSD controller and/or a flash subsystem.

In some example embodiments, the storage server 102 may be communicatively connected to the application server 106 via the service entity 104. In some example embodiments, the application server 106 may operate as a host for the storage server 102. The application server 106 may access the one or more storage devices 108 associated with the storage server 102 through the communication network.

In some example embodiments, the users may access the one or more host applications from the application server 106, as services, remotely through their connected devices (also referred to as one or more client devices), through the service entity 104. In some example embodiments, the users may alternatively or additionally access one or more storage devices through the service entity 104 for executing the one or more host applications. In some example embodiments, the service entity 104 may provide on-demand access to the one or more storage devices 108, through the communication network. For example, the users may provide commands for moving and/or replicating data between the one or more host applications and/or the one or more storage devices 108. In some example embodiments, the service entity 104 may provide the services via a cloud network, which may include, but not limited to, one or more of Infrastructure as a Service (IaaS), Platform as a Service (PaaS), Software as a Service (SaaS), Storage as a Service (StaaS), Security as a Service (SECaaS), Test Environment as a Service (TeaaS), and Application Program Interface (API) as a Service (APIaaS).

In some example embodiments, the service entity 104 may generate a power token for each of the one or more host applications in response to, a service request related to the one or more host applications received from the application server 106. In some example embodiments, the application server 106 may be associated with one or more client devices of the users.

In some example embodiments, the power token may be generated for each of one or more host applications. As an example, when the host application is or includes or is included in an Artificial Intelligence and Machine Learning (AI/ML) application which requests access to a storage device, the service entity 104 generates a power token indicating the power requirement or the power expectations corresponding to the AI/ML application. For example, the generated power token may be “power_token (25 W, 12 h, 580 MHz)”, which includes three parameters: a wattage expectation or requirement of 25 watts, a duration of 12 hours, and a storage device controller frequency of 580 MHz. The wattage requirement indicates the energy required by or expected to be used by the AI/ML application, the duration indicates the time duration for which the energy is required or desired, and the storage device controller frequency indicates the frequency of the storage device controller, such as the SSD controller.

Alternatively or additionally in some example embodiments, when the host application is or includes or is included in a log analysis application and requests access to a storage device, the service entity 104 generates a power token indicating the power requirement or expectation corresponding to the log analysis application. For instance, the generated power token may be “power_token (18 W, 9 h, 435 MHz)”, which includes three parameters: a wattage requirement or expectation of 18 watts, a duration of 9 hours, and the storage device controller frequency of 435 MHz. The wattage requirement indicates the energy required by or expected to be used by the log analysis application, the duration indicates the time duration for which the energy is required or desired, and the storage device controller frequency indicates the frequency of the storage device controller.

In some example embodiments, the power token generated by the service entity 104 for each of the one or more host applications may be based on the corresponding applications workload requirements or expectations. For example, the workload requirements may include, without limiting to, read-intensive, write-intensive, mixed, archival, and backup. In some example embodiments, the service entity 104 may also consider additional factors such as the corresponding host application's priority, the expected data throughput, and the latency requirements for each of the one or more host applications.

In some example embodiments, the power token may be generated based on a request received from the users who may access one or more host applications from the application server 106, as services. In some example embodiments, the request received from the users may include, without limiting to, the application details and the duration for which the application is required to be or expected to be executed. In some example embodiments, the one or more host applications may be configured to request the service entity 104 for power token generation, by itself. For instance, applications such as backup systems, which may be set to perform backups at regular intervals, may initiate the request for power token generation for scheduled application execution without manual intervention.

In some example embodiments, the storage server 102 may receive the power token generated for each of one or more host applications from the service entity 104. In some example embodiments, the power token may indicate a power requirement or a power expectation corresponding to each of the one or more host applications. In some example embodiments, the power token indicating the power requirement/expectation may include, without limiting to, at least one of a wattage requirement or expectation for executing the corresponding host application, a duration of the wattage requirement or expectation and storage device controller frequency, e.g., the frequency of the storage device controller, such as the SSD controller.

In some example embodiments, upon receiving the power token generated for each of one or more host applications from the service entity 104, the storage server 102 may dynamically configure one or more power tiers based on the power expectation indicated by the power token received for each of the one or more host applications. In some example embodiments, the one or more power tiers may be dynamically configured by grouping one or more storage devices to operate at a desired power state or power level. The storage server 102 may allocate each of the one or more host applications to a suitable power tier from among the one or more power tiers for execution at the desired power state, based on the power token received for each of the one or more host applications. For instance, when the storage server 102 receives the power token generated for each of one or more host applications from the service entity 104, such as “power_token (25 W, 9 h, 435 MHz)”, “power_token (18 W, 9 h, 435 MHz)”, and “power_token (9 W, 4 h, 435 MHz)”, the storage server 102 may dynamically configure one or more power tiers. Each power tier comprises a group of storage devices configured to operate at a specific power state corresponding to the power requirement indicated by the received power token. For example, one of the power tiers may include one or more storage devices configured to operate at 25 W or around 25 W, which may be considered as a highest power tier among the other dynamically configured power tiers. Similarly, another power tier may include one or more storage tiers configured to operate at 18 W or around 18 W, which may be considered as a medium power tier among the other dynamically configured power tiers. Similarly, another power tier may include one or more storage tiers configured to operate at 9 W or around 9 W, which may be considered as a medium power tier among the other dynamically configured power tiers. These wattages indicated for each of the power tiers are only for illustrative purpose and should not be construed as a limitation. The power tiers can be dynamically configured at any wattage based on the requests received by the service entity 104 and corresponding power token generated. Similarly, even the number of power tiers, the number of storage devices for each power tier, and the wattages at which each of the storage devices in the respective power tiers operate vary dynamically based on the type of requests the service entity 104 and corresponding power token generated. For instance, assume a first scenario, where the storage server 102 receives maximum power tokens to perform the critical tasks requiring expecting to use a wattage between 20-25 W, when compared to other power tokens, then the storage server 102 dynamically configures a power tier of wattage 25 W and includes or associates one or more storage devices 108, for instance, 100 storage devices, under this power tier to operate at the power state as set for the power tier of wattage 25 W required to perform the tasks indicated by the power tokens. For instance, assume a second scenario, where the storage server 102 receives a maximum number of power tokens indicating backup or archival tasks requiring or expecting to use a wattage of 9 W or below, then the storage server 102 dynamically configures a power tier of wattage 9 W and includes or associates one or more storage devices 108, for instance, 120 storage devices, under this power tier to operate at the power state as set for the power tier of wattage 9 W required to or expected to perform the backup or archival tasks indicated by the power tokens.

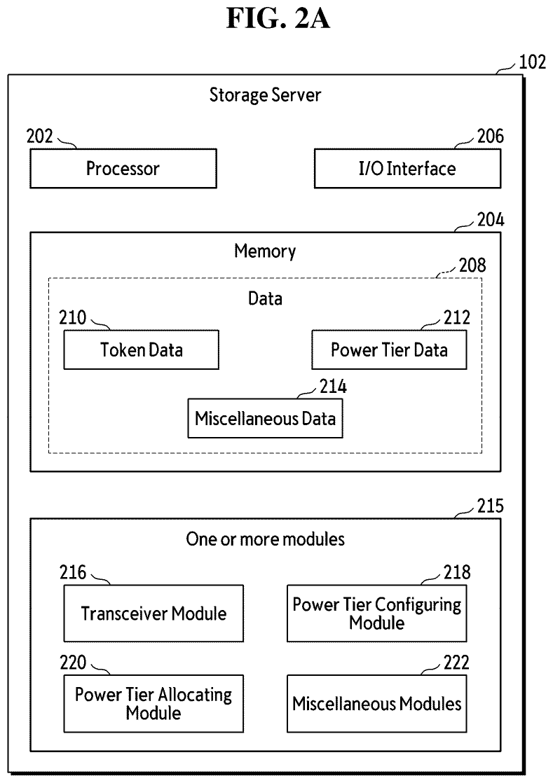

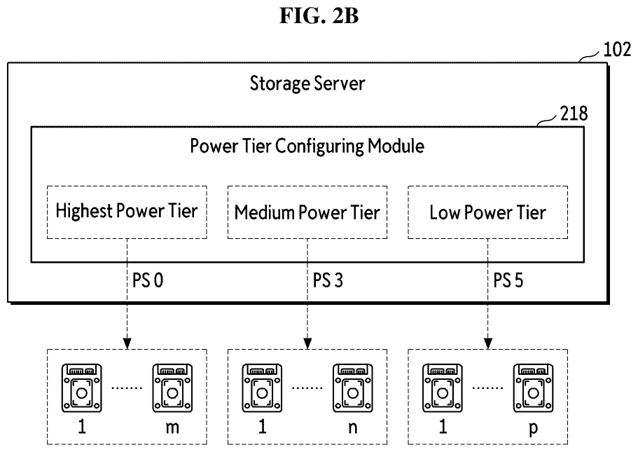

FIG. 2A shows a detailed block diagram of a storage server 102 for managing power state of one or more storage devices 108 associated with the storage server 102, in accordance with some embodiments of the present disclosure.

In some example embodiments, the storage server 102 may include a processor 202, a memory 204 and an I/O interface 206. In some example embodiments, the memory 204 may be communicatively coupled to the processor 202. The processor 202 may be configured to perform one or more functions of the storage server 102, using data 208 and one or more modules 215 of the storage server 102. In some example embodiments, the memory 204 may store data 208. In some example embodiments, using I/O interface 206 the storage server 102 may communicate with the service entity 104.

In some example embodiments, the data 208 stored in the memory 204 may include, without limitation, token data 210, power tier data 212, and miscellaneous data 214. In some example embodiments, the data 208 may be stored within the memory 204 in the form of various data structures. Additionally or alternatively, the data 208 may be organized using data models, such as relational and/or hierarchical data models. The miscellaneous data 214 may include various temporary data and files generated by the one or more modules 215.

In some example embodiments, token data 210 may include one or more power tokens received by the storage server 102 from the service entity 104 associated with the storage server 102. The one or more power tokens may be generated for each of one or more host applications by the service entity 104 associated with the storage server 102. In some example embodiments, the one or more power tokens may indicate a power requirement or expectation corresponding to each of the one or more host applications. In some example embodiments, the power tokens indicating the power requirements may include, without limitation, at least one of a wattage requirement or expectation for executing the corresponding host application, a duration of the wattage requirement or expectation, and storage device controller frequency. For instance, “power_token (25 W, 9 h, 435 MHz)”, indicates a wattage requirement of 25 Watts, a duration of 9 hours, and a storage device controller frequency of 435 MHz.

In some example embodiments, the time duration for which the energy is expected to be used by the one or more host applications may be indicated by the user to the service entity 104, on demand basis. The service entity 104 may generate the power token corresponding to the one or more host applications, based on the information received from the user. In some example embodiments, if the time duration required by or expected to be used by one or more host applications is less than the time indicated by the user, the storage server 102 may prompt the user to extend the service as the end of this period approaches. As an example, if the user initially indicates a duration of 9 hours, the storage server 102 may prompt the user to extend the service as the end of this period approaches. For example, when 80% of the allocated time has elapsed, the storage server 102 may notify the user to decide whether to extend the service, ensuring continuous operation without interruption.

In some example embodiments, the token data 210 may alternatively or additionally include the workload requirement or expectation of the corresponding host applications, in addition to or in lieu of the power requirement of the corresponding host applications. For example, the workload requirements may include, without limitation, one or more of an indication of a read-intensive application, a write-intensive application, a mixed (read-write intensive) application, an archival application, and a backup application. For instance, a host application such as an AI/ML application may be read-write intensive due to the frequent updates and storage of large datasets, whereas a host application such as a database application might be read-intensive as such an application primarily handles data retrieval operations.

In some example embodiments, power tier data 212 may include data related to one or more power tiers. The power tiers may be categorized into one or more Power States (PS), for instance, highest power state, medium power state, and low power state. In some example embodiments, the highest power state may indicate a group of storage devices configured to operate at a power state for example, at 25 W, which may be the highest among the dynamically configured power tiers. Similarly, the medium power state and low power state may include one or more storage devices configured to operate at power state for example, 18 W and 9 W, respectively, with the power state of the medium power tier being higher than the power state of the low power tier. In some example embodiments, the number of power states and/or the number of storage devices storage devices configured to operate at a power state may vary dynamically, for example based on the type of requests received from the service entity 104 and corresponding power tokens generated. In some example embodiments, each of the one or more power tiers may comprise a group of storage devices configured to operate at a desired PS. As an example, the highest power tiers might operate at around 25 W, medium power tiers at 18 W, and low power tiers at 9 W. In some example embodiments, the data related to the one or more power tiers may include power wattage to be set for the one or more storage devices 108 based on a power requirement of each of the one or more host applications. For example, power wattage to be set for the one or more storage devices 108 may be 25 W, 18 W, and 9 W etc. based on a power requirement of each of the one or more host applications. The corresponding power states for the one or more storage devices 108 of power wattages 25 W, 18 W, and 9 W may be highest power state (PS 0), medium power state (PS 3) and low power state (PS 5) respectively. As shown in Table 1 below, at the highest power state (PS 0), the one or more storage devices 108 consume around 25 W, making them suitable for power intensive tasks such as AI/ML applications. In the medium power state (PS 3), the one or more storage devices 108 use approximately 18 W, which may be ideal for database applications and/or log analysis. For less demanding tasks like backup and/or archival, the one or more storage devices 108 operate in the low power state (PS 5), consuming about 9 W.

TABLE 1

| S. | | Power | Power | Host |
|---|---|---|---|---|
| NO | Example of Power Token | Tier | State | Application |
| 1 | power_token(25 W, 12 h, | Highest | PS 0 | AI/ML |
| | 580 MHz) | | | Application |
| 2 | power_token(18 W, 9 h, | Medium | PS 3 | DB Apps/ |
| | 435 MHz) | | | Log Analysis |
| 3 | power_token(9 W, 8 h | Low | PS 5 | Backup/ |
| | 290 MHz) | | | Archival |

In some example embodiments, the data 208 may be processed by the one or more modules 215 included in the storage server 102. In some implementations or example embodiments, the one or more modules 215 may be communicatively coupled to the processor 202 for performing one or more functions of the storage server 102. In some example embodiments, the one or more modules 215 may include, without limiting to, transceiver module 216, power tier configuring module 218, power tier allocating module 220 and miscellaneous modules 222.

As used herein, the term module may refer to one or more of an Application Specific Integrated Circuit (ASIC), an electronic circuit, a hardware processor (shared, dedicated, and/or group) and memory that execute one or more software and/or firmware programs, a combinational logic circuit, and/or other suitable components that provide the described functionality. In an implementation, each of the one or more modules 215 may be configured as stand-alone hardware computing unit; example embodiments are not limited thereto. In some example embodiments, the miscellaneous modules 222 may be used to perform various miscellaneous functionalities of the storage server 102. It will be appreciated that such one or more modules 215 may be represented as a single module or a combination of different modules.

In some example embodiments, the transceiver module 216 may receive the power token generated for each of the one or more host applications from the service entity 104 associated with the storage server 102. The power token may indicate a power requirement or expectation corresponding to each of the one or more host applications. In some example embodiments, the power token indicating the power requirement may include, without limiting to, at least one of a wattage requirement or expectation for executing the corresponding host application, a duration of the wattage requirement and a storage device controller frequency. For instance, the received power token may be “power_token (x W, y H, z MHz),” which includes three parameters: a wattage requirement of ‘x’ Watts, a duration of ‘y’ Hours, and a storage device controller frequency of ‘z’ MHz.

In some example embodiments, the power tier configuring module 218 may configure dynamically one or more power tiers based on the power requirement indicated by the power token received for each of the one or more host applications.

Each of the components listed in FIG. 2A can communicate with others included in FIG. 2A, to send and/or receive various information, over a bus (not shown) such as a wired bus and/or a wireless bus, formatted in various formats such as in a digital format and/or an analog format, sent and/or received in various manners such as but not limited to a broadcast manner, a one-way manner, or a two-way manner. The information may be one or more of data and/or commands, and may be sent and/or received in a parallel manner and/or a serial manner. Example embodiments are not limited thereto.

FIG. 2B shows an exemplary block diagram of one or more power tiers configured based on the power requirement indicated by the power token received for each of the one or more host applications.

As shown in FIG. 2B each of the one or more power tiers comprises a group of storage devices (1-n) configured to operate at a desired power state. In some example embodiments, the power tier configuring module 218 may use the received power tokens, to determine the appropriate power tier and PS for each application. As shown in Table 2, for instance, a power token with requirements or expectations of 25 W, 12 hours, and 580 MHz is used to configure the highest power tier, operating in power state PS 0. The highest power tier may include ‘m’ storage devices configured to operate at the desired power state PS 0. Another token with 18 W, 9 hours, and 435 MHz is used to configure a medium power tier, operating in power state PS 3. The medium power tier may include ‘n’ storage devices configured to operate at the desired power state PS 3. The token with 9 W, 8 hours, and 290 MHz is used to configure the low power tier, operating in power state PS 5. The low power tier may include ‘p’ storage devices configured to operate at the desired power state PS 5. For example, if there are 32 storage devices, a group of 12 (m=12) storage devices is assigned to the highest power tier based on the power requirement indicated by the power token received for each of the one or more host applications. Similarly, group of 10 (n=10) storage devices is allocated to the medium power tier, and the remaining group of 10 (p=10) storage devices are allocated to the low power tier.

TABLE 2

| S. | | Power | Power |
|---|---|---|---|
| NO | Example of Power Token | Tier | State |
| 1 | power_token(25 W, 12 h, 580 MHz) | Highest | PS 0 |
| 2 | power_token(18 W, 9 h, 435 MHz) | Medium | PS 3 |
| 3 | power_token(9 W, 8 h, 290 MHz) | Low | PS 5 |

In some example embodiments, the power tier allocating module 220 may allocate each of the one or more host applications to a suitable power tier among the one or more power tiers for execution at the desired power state, based on the power token received for each of the one or more host applications. As shown in Table 3, for instance, the highest power tier (PS 0) may be allocated to the one or more host applications with power tokens indicating a requirement or expectation of 25 watts or greater, and the storage device controller operating frequencies for the SSD controllers are between 507 and 580 MHz. The highest power tier may be suitable for read/write intensive, mission-critical workloads, such as AI/ML applications. The highest power tier (PS 2) is allocated to the one or more host applications with power tokens indicating a requirement of 20 to 24 watts, the storage device controller operating frequencies of the SSD controllers are between 435 and 506 MHz. The high power tier is suitable for transactional workloads such as OLTP (Online Transaction Processing) and batch processing, which may be host applications running in business hours and require more power.

Further, as shown in the Table 3, the power tier allocating module 220 may allocate for instance, without limitation, the medium power tier (PS 3) to applications with power tokens indicating a requirement or expectation of 15 to 19 watts, and the storage device controller operating frequencies for these one or more host applications are between 362 and 434 MHz. This medium power tier may be suitable for web application workloads. Furthermore, as shown in the Table 3, the power tier allocating module 220 may allocate for instance, without limitation, the low power tier (PS 4) to applications with power tokens indicating a requirement or expectation of 9 to 14 watts, the storage device controller operating frequencies of the SSD controllers are between 290 and 361 MHz. This low power tier may be suitable for archival workloads which may be host applications running during non-business hours and require less power. This dynamic allocation of power tiers ensures or helps to ensure that each of the one or more host applications operate efficiently within its allocated power tier, which may be advantageous in improving or optimizing performance and/or power consumption based on the specific requirements and expectations of the workload.

TABLE 3

| | | | Operating | | |
|---|---|---|---|---|---|
| | | Power | Power Range | Controller | |
| S. NO | Components | State(PS) | (Watts) | Frequency(MHz) | Work load |
| 1 | Highest Power Tier | PS 0 | 25 and beyond | 507-580 | Read/write intensive |
| | | | | | (mission critical) |
| 2 | High Power Tier | PS 2 | 20-24 | 435-506 | Transactional workloads |
| | | | | | (OLTP/batch) |
| 3 | Medium Power Tier | PS 3 | 15-19 | 362-434 | Web workloads |
| 4 | Low Power Tier | PS 4 | 9-14 | 290-361 | Archival |

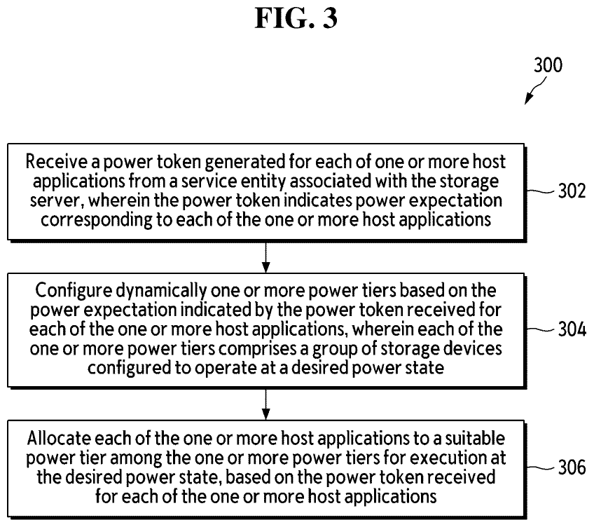

FIG. 3 shows a flowchart illustrating a method of managing power state of one or more storage devices 108 associated with a storage server 102, in accordance with some embodiments of the present disclosure.

As illustrated in FIG. 3, the method 300 may include one or more blocks illustrating a method of managing power state of one or more storage devices 108 associated with a storage server 102. The method 300 may be described in the general context of computer executable instructions. Generally, computer executable instructions can include one or more of routines, programs, objects, components, data structures, procedures, modules, and functions, which perform specific functions or implement specific abstract data types.

The order in which the method 300 is described is not intended to be construed as a limitation, and any number of the described method blocks can be combined in any order to implement the method and in some instances concurrently or at least at overlapping times and/or iteratively. Additionally, or alternatively, individual blocks may be deleted from the methods without departing from the scope of the subject matter described herein. Furthermore, the method can be implemented in any suitable hardware, software, firmware, or combination thereof.

At block 302, the method 300 includes receiving, by a processor 202 of the storage server 102, a power token generated for each of one or more host applications from a service entity 104 associated with the storage server 102. The power token indicates power requirement or expectations corresponding to each of the one or more host applications. In some example embodiments, the power token may be generated by the service entity 104 for each of the one or more host applications in response to a service request related to the one or more host applications received from one or more client devices associated with the storage server 102. In some example embodiments, the power token indicating the power requirement or expectation may include, but not limited to, at least one of a wattage requirement or expectation for executing the corresponding host application, a duration of the wattage requirement, and a controller frequency.

At block 304, the method 300 includes configuring dynamically, by the processor 202 of the storage server 102, one or more power tiers based on the power requirement indicated by the power token received for each of the one or more host applications. Each of the one or more power tiers comprises a group of storage devices configured to operate at a desired power state. The number of storage devices assigned to each power tier may be the same, or at least one power tier may have a different number of storage devices assigned thereto; example embodiments are not limited thereto.

In some example embodiments, a power tier may be assigned based on, for example, a function of each of the information included in the power token. For example, if the power token includes of a wattage requirement for executing the corresponding host application, a duration of the wattage requirement, and a controller frequency the function, then the power tier assigned to the host application may correspond to a weighted sum and/or weighted product of each of the wattage requirement, the duration, and the controller frequency. In some example embodiments, a host application with a low weighted product of each of the wattage requirement, the duration, and the controller frequency may be assigned to a low power tier; another host application with a medium weighted product of each of the wattage requirement, the duration, and the controller frequency may be assigned to a medium power tier; and a host application with a high a weighted product of each of the wattage requirement, the duration, and the controller frequency may be assigned to a high power tier. The weights used in the weighted sum and/or the weighted product may be dynamically determined based on, for example, a history of power consumption such as but not limited to an autoregressive integrated moving average (ARIMA). Example embodiments are not limited thereto.

At block 306, the method 300 includes allocating, by the processor 202 of the storage server 102, each of the one or more host applications to a suitable power tier among the one or more power tiers for execution at the desired power state, based on the power token received for each of the one or more host applications. In some example embodiments, after the allocation, respective devices may execute the corresponding host application.

### Computer System

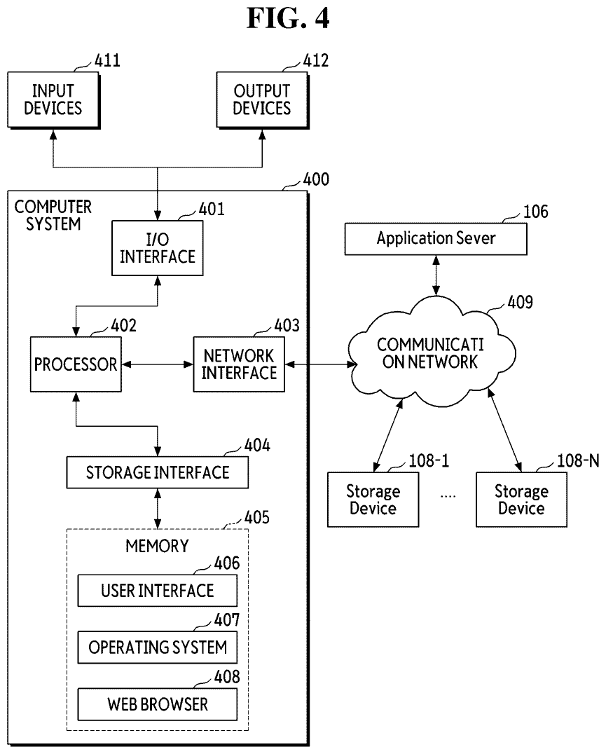

FIG. 4 illustrates a block diagram of an exemplary computer system 400 for implementing some example embodiments consistent with inventive concepts. In some example embodiments, the computer system 400 may be a storage server 102. The storage server 102 may be communicatively connected to a service entity 104 associated with the storage server 102. In some example embodiments, the service entity 104 associated with the storage server 102 may be configured within the storage server 102. In some example embodiments, the storage server 102 may be communicatively connected to one or more storage devices 108. The computer system 400 may include a central processing unit (“CPU” or “processor” or “memory controller”) 402.

The processor 402 may comprise at least one data processor for executing program components for executing user- or system-generated host application execution processes. A user may include an administrator, a network manager, an application developer, a programmer, an organization, or any system/sub-system being operated parallelly to the computer system 400. The processor 402 may include specialized processing units such as integrated system (bus) controllers, memory controllers/memory management control units, floating point units, graphics processing units, digital signal processing units, etc.

The processor 402 may be disposed in communication with one or more Input/Output (I/O) devices (411 and 412) via I/O interface 401. The I/O interface 401 may employ communication protocols/methods such as, without limitation, one or more of audio, analog, digital, stereo, IEEE®-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE® 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE) or the like), etc. Using the I/O interface 401, the computer system 400 may communicate with one or more I/O devices 411 and 412.

In some example embodiments, the processor 402 may be disposed in communication with a network 409 via a network interface 403. The network interface 403 may communicate with the network 409. The network interface 403 may employ connection protocols including, without limitation, direct connect, one or more of Ethernet (e.g., twisted pair 10/100/1000 Base T), Transmission Control Protocol/Internet Protocol (TCP/IP), token ring, IEEE® 802.11a/b/g/n/x, etc.

In some example embodiments, the network 409 may be implemented as one or more of the several types of networks, such as intranet or Local Area Network (LAN) and such within the organization. The network 409 may either be a dedicated network or a shared network, which represents an association of one or more of several types of networks that use a variety of protocols, for example, Hypertext Transfer Protocol (HTTP), Transmission Control Protocol/Internet Protocol (TCP/IP), Wireless Application Protocol (WAP) etc., to communicate with each other. Alternatively or additionally, the network 409 may include a variety of network devices, including one or more of routers, bridges, servers, computing devices, storage devices, etc. Using the network interface 403 and the network 409, the computer system 400 may communicate with the one or more storage devices 108 and an application server 106. In some example embodiments, the one or more storage devices 108 may include, but are not limited to, storage devices such as Hard Disk Drives (HDDs), Solid-State Drives (SSDs), and tape drives.

In some example embodiments, the processor 402 may be disposed in communication with a memory 405 (e.g., RAM, ROM, etc. as shown in FIG. 4) via a storage interface 404. The storage interface 404 may connect to memory 405 including, without limitation, one or more of memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user/application interface 406, an operating system 407, a web browser 408, and the like. In some example embodiments, computer system 400 may store user/application data, such as the data, variables, records, etc. as described in this invention. Such databases may be implemented as fault-tolerant, relational, scalable, secure databases such as Oracle® or Sybase®.

The operating system 407 may facilitate resource management and operation of the computer system 400. Examples of operating systems include, without limitation, APPLE® MACINTOSH® OS X®, UNIX®, UNIX-like system distributions (e.g., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM® OS/2®, MICROSOFT® WINDOWS® (XP®, VISTA®/7/8, 10 etc.), APPLE® IOS®, GOOGLE™ ANDROID™, BLACKBERRY® OS, or the like.

The user interface 406 may facilitate display, execution, interaction, manipulation, or operation of program components through textual or graphical facilities. For example, the user interface 406 may provide computer interaction interface elements on a display system operatively connected to the computer system 400, such as one or more of cursors, icons, check boxes, menus, scrollers, windows, widgets, and the like. Further, Graphical User Interfaces (GUIs) may be employed, including, without limitation, APPLE® MACINTOSH® operating systems' Aqua®, IBM® OS/2®, MICROSOFT® WINDOWS® (e.g., one or more of Aero, Metro, etc.), web interface libraries (e.g., ActiveX®, JAVA®, JAVASCRIPT®, AJAX, HTML, ADOBE® FLASH®, etc.), or the like.

The web browser 408 may be a hypertext viewing application. Secure web browsing may be provided using Secure Hypertext Transport Protocol (HTTPS), Secure Sockets Layer (SSL), Transport Layer Security (TLS), and the like. The web browsers 408 may utilize facilities such as AJAX, DHTML, ADOBE® FLASH®, JAVASCRIPT®, JAVA®, Application Programming Interfaces (APIs), and the like. Further, the computer system 400 may implement a mail server stored program component. The mail server may utilize facilities such as ASP, ACTIVEX®, ANSI® C++/C#, MICROSOFT®, .NET, CGI scripts, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some example embodiments, the computer system 400 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, and the like

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

### Some Advantages of Some Example Embodiments are Illustrated Herein

Some example embodiments provide a method and/or apparatus (storage server) for managing power state of one or more storage devices associated with a storage server.

Alternatively or additionally, some example embodiments provide a method and/or an apparatus, e.g., a storage server for managing power state of one or more storage devices associated with the storage server based on their actual workload.

According to some example embodiments, each of the one or more host applications are allocated to a suitable power tier among the one or more power tiers that are dynamically configured for execution at the desired power state, which in turn may advantageously reduce idle power, and/or minimize or reduces power state transitions of the storage devices.

By implementing dynamic power management strategies as discussed the storage industry can reduce or significantly reduce the power consumption and/or the carbon emissions of data centers, leading to lower operational costs and a more sustainable future, while maintaining cost-efficiency during off-peak periods.

In light of the technical advancements provided by inventive concepts, the claimed steps or operations, as discussed above, are not routine, conventional, or well-known aspects in the art, as the claimed steps or operations provide the aforesaid solutions to the technical problems existing in the conventional technologies. The claimed steps or operations may help to clearly bring an improvement in the functioning of the system itself, as the claimed steps or operations provide a technical solution to a technical problem.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

A description of some example embodiments with several components in communication with each other does not imply that all such components are required or preferred. On the contrary, a variety of optional components are described to illustrate the wide variety of possible embodiments of inventive concepts.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article or a different number of devices/articles may be used instead of the shown number of devices or programs. The functionality and/or features of a device may be alternatively or additionally embodied by one or more other devices which are not explicitly described as having such functionality/features. Thus, other embodiments of invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, example embodiments are intended to be illustrative, but not limiting, of the scope of the invention, which is set forth in the following claims.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

While various aspects and some example embodiments have been disclosed herein, other aspects and example embodiments will be apparent to those of ordinary skill in the art. The various aspects and example embodiments disclosed herein are for purposes of illustration and are not intended to be limiting, with the true scope and spirit being indicated by the following claims. Additionally, example embodiments are not necessarily mutually exclusive with one another. For example, some example embodiments may include one or more features described with reference to one or more figures, and may also include one or more other features described with reference to one or more other figures.

We claim:

1. A method of managing a power state of one or more storage devices associated with a storage server, the method comprising:
receiving, by the storage server, a power token generated for each of one or more host applications from a service entity associated with the storage server, wherein the power token indicates a power expectation corresponding to each of the one or more host applications;
configuring dynamically, by the storage server, one or more power tiers based on the power expectation indicated by the power token received for each of the one or more host applications, wherein each of the one or more power tiers comprises a group of storage devices configured to operate at a desired power state; and
allocating, by the storage server, each of the one or more host applications to a suitable power tier among the one or more power tiers for execution at the desired power state, based on the power token received for each of the one or more host applications.

2. The method as claimed in claim 1, wherein the power token is generated by the service entity for each of the one or more host applications in response to,
a service request related to the one or more host applications received from one or more client devices associated with the storage server.

3. The method as claimed in claim 1, wherein the power token indicating the power expectation comprises at least one of a wattage expectation for executing the corresponding host application, a duration of the wattage expectation, and a controller frequency.

4. A storage server configured to manage a power state of one or more storage devices associated with the storage server, the storage server comprising:
a processor; and
a memory communicatively coupled to the processor, wherein the memory is configured to store processor-executable instructions, which, on execution, causes the storage server to:
receive a power token generated for each of one or more host applications from a service entity associated with the storage server, wherein the power token indicates power expectation corresponding to each of the one or more host applications;
configure dynamically one or more power tiers based on the power expectation indicated by the power token received for each of the one or more host applications, wherein each of the one or more power tiers comprises a group of storage devices associated with the storage server that are configured to operate at a desired power state; and
allocate each of the one or more host applications to a suitable power tier among the one or more power tiers for execution at the desired power state, based on the power token received for each of the one or more host applications.

5. The storage server as claimed in claim 4, wherein the power token is generated by the service entity for each of the one or more host applications in response to,
a service request related to the one or more host applications received from one or more client devices associated with the storage server.

6. The storage server as claimed in claim 4, wherein the power token indicating the power expectation comprises at least one of a wattage expectation for executing the corresponding host application, a duration of the wattage expectation and a controller frequency.

7. A system, comprising:
one or more storage devices; and
a storage server configured to manage a power state of the one or more storage devices associated with the storage server, the storage server comprising,
a processor, and
a memory communicatively coupled to the processor, wherein the memory is configured to store processor-executable instructions, which, on execution, causes the system to,
receive a power token generated for each of one or more host applications from a service entity associated with the storage server, wherein the power token indicates power expectation corresponding to each of the one or more host applications,
configure dynamically one or more power tiers based on the power expectation indicated by the power token received for each of the one or more host applications, wherein each of the one or more power tiers comprises a group of storage devices associated with the storage server that are configured to operate at a desired power state, and
allocate each of the one or more host applications to a suitable power tier among the one or more power tiers for execution at the desired power state, based on the power token received for each of the one or more host applications, wherein
each of the one or more storage devices are configured to execute the respective host applications allocated to the respective one or more storage devices based on the power tiers.

8. The system of claim 7, wherein the power tiers include a highest power tier, a high power tier, a medium power tier, and a low power tier.

9. The system of claim 8, wherein the processor is configured to assign an artificial intelligence/machine learning (AI/ML) applications to the highest power tier among the power tiers.

10. The system of claim 8, wherein the processor is configured to assign a transactional application to the high power tier among the power tiers.

11. The system of claim 8, wherein the processor is configured to assign a web application to the medium power tier among the power tiers.

12. The system of claim 8, wherein the processor is configured to assign an archival application to the low power tier among the power tiers.
